(19) United States
(12) Patent Application Publication
(10) Pub. No.: US 2005/0086311 A1
(43) Pub. Date: Apr. 21, 2005

(54) Regulating self-disclosure for video messenger

(76) Inventors: Noel Enete, Seal Beach, CA (US); Brian D. Heikes, Ashburn, VA (US)

Correspondence Address: FISH & RICHARDSON P.C., 1425 K STREET, N.W., 11TH FLOOR, WASHINGTON, DC, 20005-3500, US

(21) Appl. No.: 10/747,624

(22) Filed: Dec. 30, 2003

Related U.S. Application Data
(60) Provisional application No. 60/450,697, filed on Mar. 3, 2003.
(60) Provisional application No. 60/450,710, filed on Mar. 3, 2003.
(60) Provisional application No. 60/471,337, filed on May 19, 2003.
(60) Provisional application No. 60/488,376, filed on Jul. 21, 2003.
(60) Provisional application No. 60/488,749, filed on Jul. 22, 2003.
(60) Provisional application No. 60/488,816, filed on Jul. 22, 2003.

(51) Int. Cl. G06F 15/16

(52) U.S. Cl. 709/206; 709/201

(57) ABSTRACT

Regulating a level of self-disclosure in an instant messaging communications session includes enabling user selection on a first instant messaging participant system of an instant messaging communications mode from at least a first available mode and a second available mode. The first available mode discloses a different amount of information about a first instant messaging participant than the second available mode. Creation of a message clip is enabled on the first instant messaging participant system according to the selected communications mode and delivery of the message clip is enabled from the first instant messaging participant system to a second instant messaging participant system.

This application claims priority from U.S. Provisional Application No. 60/450,697, filed Mar. 3, 2003, U.S. Provisional Application No. 60/450,710, filed Mar. 3, 2003, U.S. Provisional Application No. 60/471,337, filed May 19, 2003, U.S. Provisional Application No. 60/488,376, filed Jul. 21, 2003, U.S. Provisional Application No. 60/488,749, filed Jul. 22, 2003, and U.S. Provisional Application No. 60/488,816, filed Jul. 22, 2003, each of which is incorporated by reference.

### TECHNICAL FIELD

This description relates to regulating self-disclosure in video communications and more particularly to regulating self-disclosure for a video messenger user.

### BACKGROUND

Online service providers facilitate access to information and services by providing interactive User Interfaces (UIs) that help users navigate to desired resources. For example, in the case of a system that enables the exchange of instant messages (IMs), a UI allows a sender to invoke actions, such as establishing a communications link, through the selection of screen objects such as icons, windows, and drop-down menus. The design of a UI has a significant impact on a sender's online experience. In particular, the icons, the windows, and the menus of a UI may be arranged to enable a sender to locate information and services quickly and easily.

Typically, during a video communications session such as a video conference or a video messaging session, users are provided a limited amount of control over the video presented to other participants.

Conventional peer-to-peer video messaging typically involves the sender system recording and uploading a video stream to be downloaded and played by the recipient system. In order to participate in a video messaging session, a user typically is required to have certain equipment, such as video recording equipment.

### SUMMARY

A clip-based and/or multi-mode approach is provided to a user of a video communications system, whereby user-defined segments of a selected video communications mode are sent (i.e., as clips). This approach allows the user to control the level of self-disclosure to other participants in a video communications session.

In one general aspect, regulation of self-disclosure in an instant messaging communications session includes enabling user selection, on a first instant messaging participant system, of an instant messaging communications mode from among at least a first available mode and a second available mode. The first available mode discloses a different amount of information about a first instant messaging participant than the second available mode. Creation of a message clip is enabled on the first instant messaging participant system according to the selected communications mode. Delivery of the message clip is enabled from the first instant messaging participant system to the second instant messaging participant system.

Implementations may provide one or more of the following features. For example, the message clip may be stored on a host system and delivered from the host system to the second instant messaging participant system. In one implementation, the first available mode is selected, a first message clip is created on the first instant messaging participant system according to the first available mode, and the first message clip is delivered from the first instant messaging participant system to the second instant messaging participant system. Also, the second available mode may be selected, a second message clip may be created on the first instant messaging participant system according to the second available mode, and the second message clip may be delivered from the first instant messaging participant system to the second instant messaging participant system.

In another general aspect, a level of self-disclosure may be regulated in an instant messaging communication system by rendering, on a first instant messaging participant system, an instant messaging application user interface for an instant messaging communications session involving at least a first instant messaging participant and a second instant messaging participant. User selection of an instant messaging communication mode from among at least a first available mode and a second available mode may be enabled on the first instant messaging participant system. The first available mode discloses a different amount of information about the first instant messaging participant then the second available mode. The user selection is enabled at least in part through display of the available modes at the instant messaging application user interface. Creation of a message clip is enabled on the first instant messaging participant system according to the selected communication mode. The message clip is created at least in part through user interaction with the instant messaging application user interface. Delivery of the message clip is enabled from the first instant messaging participant system to a second instant messaging participant system in response to user interaction with the instant messaging application user interface.

Implementations may contain one or more of the following features. For example, user selection of a text communications mode, an audio communications mode, a still photograph communications mode, and a video communications mode may be enabled. Enabling creation of a message clip may include enabling selection of a pre-stored message clip. The message clip may be stored on a host system.

In one implementation, the first available mode is selected. A first message clip is created on the first instant messaging participant system according to the first available mode and the first message clip is delivered from the first instant messaging participant system to the second instant messaging participant system. Also, the second available mode may be selected, a second message clip may be created on the first instant messaging participant system according to the second available mode, and the second message clip may be delivered from the first instant messaging participant system to the second instant messaging participant system.

Aspects of regulating self disclosure may be implemented by an apparatus and/or by a computer program stored on a computer readable medium. The computer readable medium may comprise a disc, a client device, a host device, and/or a propagated signal. In addition, aspects of regulating self disclosure may be implemented in a client/host context or in a standalone or offline client device. The self disclosure may be rendered in a client/host context and may be accessed or updated through a remote device in a client/host environment. The self disclosure also may be rendered by the standalone/offline device and may be accessed or updated through a remote device in a non-client/host environment such as, for example, a LAN server serving an end user or a mainframe serving a terminal device.

Other features will be apparent from the following description, including the drawings, and from the claims.

### DESCRIPTION OF DRAWINGS

FIGS. 1-4 are block diagrams of exemplary communications systems.

FIGS. 5-7 are flow charts of exemplary processes that may be implemented by systems such as those of FIGS. 1-4.

FIGS. 8-13 are illustrations of different graphical user interfaces that may be implemented by systems such as those of FIGS. 1-4 when executing processes such as those of FIGS. 5-7.

For brevity, several elements in the figures described below are represented as monolithic entities. However, as would be understood by one skilled in the art, these elements each may include numerous interconnected computers and components designed to perform a set of specified operations and/or may be dedicated to a particular geographic region.

### DETAILED DESCRIPTION

By providing a clip-based and/or multi-mode approach to regulating self-disclosure, users are provided a greater degree of control in using the video communications system. In particular, users are able to control what other participants in the video communication session learn about them.

In a clip-based approach, a message may be created as a discrete video clip, which may be edited after creation. Recording restrictions (e.g., time, size, number) may be placed on the clips. For example, the user may not be able to record a video message longer than 15 seconds. The video communications system may be configured, however, to automatically store a video message when the limit is reached and to begin recording another video message without user intervention. The clips may then be reviewed by the user before sending.

A clip-based approach challenges the assumption that video communications must be “live”. The clip-based approach to video communications allows a user to refine a given message from the user to another participant. A message is created as a discrete unit of a length selected by the user, subject to recording restrictions mentioned above. Once created, the message may be edited or deleted and re-recorded. The message is not sent until the user is satisfied and decides to send it. By using a clip-based approach, the user is not “put on the spot” in a “live” video or audio situation. The other participants in the video communications session are able to receive and view the user's message only after the user has decided to release it. Thus, the pace of the video communications session may vary. A communications session may proceed very rapidly, in near real time, or the interval between messages in a communications session may be much longer, as the user releases only those messages that are satisfactory to the user.

The effects of latency experienced by the user are reduced since real time/instantaneous delivery is not required. Instead, successive messages are being recorded and sent once the user is comfortable sending the message. Typically, the nature of the clip-based approach leads to a time lag between successive messages. Also, the clip-based approach results in improved scalability of the video communications system because the time between sending successive clips allows other users to make use of the same portion of system bandwidth.

A multi-mode approach to self-disclosure allows the user to control the amount/type of user information that is revealed in a given message. Multiple modes of communication are provided to the user in support of this approach. Modes of communications may include, for example, text only, pre-stored video clips, audio only, a still picture plus audio (“picture plus sound”), and video plus audio. Different modes reveal different levels of information about the user. For example, video plus audio reveals more information about the user than audio only. However, as described above, before sending any message, the user has the opportunity to edit or re-record the video clip until the user is satisfied with it. Also, the user may switch from one mode to a different mode before sending. For example, the user may switch from full video to picture plus sound by substituting a photograph for a video recording while keeping the sound recording portion of the original video clip.

In a multi-mode approach, the user may choose one of the available modes to record a message. As the user becomes more comfortable, the user may choose to increase the level of self-disclosure by selecting a different mode. For example, the user may begin a conversation with the most restrictive available mode such as, for example, sending a text-only message as is currently done in a typical text-based IM session. As the user becomes more comfortable in the conversation and wishes to increase the level of self-disclosure, the user may choose to send a message using a less restrictive mode. For instance, the user may choose to send a pre-stored video clip, such as a clip from a movie, cartoon, or TV show. Next, or as an alternative, the user may choose to send a message using an even less restrictive mode. For example, the user may send a still picture with an audio track of the user's voice (picture plus sound). Yet again, the user may choose to send a message using the least restrictive available mode of communications. For example, the user may record a video clip containing video and audio of the user.

One example of a video communications system is a video messenger system such as is described in co-pending U.S. patent application Ser. No. 09/911,799, filed Jul. 25, 2001, which is incorporated herein by reference. Such a video messenger system provides a dedicated user interface (UI) for creating and visually perceiving or viewing the entire thread of the conversation. The UI enables the creation and viewing of messages from the user and messages from the participants, thus allowing the user to focus on just that communications session, and also shows presence information regarding the participants in the communications session. The video messenger UI is designed to permit easy and intuitive selection between the different levels of self-disclosure when creating the message. The UI has an integrated tool to create the video, audio, or text messages. A pre-recoded clip may be easily located and inserted into a message. There is minimal risk of the message being improperly addressed.

The described approach is useful for applications of video communications, such as video messaging. Examples include personal video messaging sessions, video conferences/meetings, and distance learning applications.

Video clips are stored at the host, or are accessible by the host, and are sent from the sender to the recipient by having the sender system send an identifier to the recipient system. As a result, the recipient system downloads the appropriate video clip from the host. In general, video clips may be user-specified, user-recorded, or host-specified.

Video clips are discrete digital files containing video and/or audio information, usually having a pre-determined maximum size or duration and stored at a host system. Video clips may be created in one of several possible modes of communications including, for example, text-only clips, audio-only clips, a still photograph plus an audio clip (picture plus sound), and video/audio clips.

Video clips may include segments from a movie, cartoon, music video, or TV show. Video clips also may be created by a user. For example, a message may be created as a discrete video clip using audio and/or visual recording equipment, and may be edited after creation. Once created, a video clip may be stored at the host. Recording restrictions (e.g., time, size, or number) may be placed on the clips. For example, the user may not be able to store or record a video message longer than 15 seconds. The video communications system may be configured, however, to automatically store a video message when the limit is reached and to begin recording another video message without user intervention. A series of related video clips may be created and may cross-reference each other as portions of a longer message.

During a video messaging session, the sender may wish to send a pre-recorded video message at multiple times during the conversation, or the sender may wish to send the pre-recorded video message to other recipients in separate conversations.

A system using host-based video clips experiences latency, but the effects of latency are reduced because real-time or instantaneous delivery is not required. The clip does not need to be recorded and uploaded by the sender prior to downloading of the clip by the recipient. Instead, a reference to the pre-recorded video clip is sent by the sender system to the recipient system, and the recipient system downloads the video clip from the host. Potential latency problems also are minimized in an asynchronous communication scheme where the speed of downloading is normally faster than the speed of uploading because a system using host-based video clips does not need to upload the video clips. Also, the use of host-based video clips may result in improved scalability of the video communications system because the sender typically does not need to upload a clip once the clip has been created and stored at the host. The bandwidth that would otherwise have been dedicated to an upload of the clip by the sender may be used by others.

Video clips are stored at the host, and a sender may choose from among the available clips to send to a recipient. Optionally, the clips may be downloaded to the sender's system to preview before sending the clip to a recipient. Host-based clips provide a set of pre-processed content to augment a video IM conversation, and also allow a user without a webcam, or other suitable video equipment such as a camera, to enable some visual presentation to a recipient with whom they participate in a video IM conversation.

A mechanism may be provided for efficiently transporting a selected host-based video clip from a sender to a recipient. In particular, the host-based clips may be sent from a sender to a recipient by embedding a file name or other identifier for the video clip. Upon receiving the identifier, the recipient system uses the identifier to download the appropriate clip from the host. The transport mechanism for host-based clips increases the efficiency of the transfer process from the sender to the receiver by eliminating the need for the sender to upload or otherwise transmit a clip. System throughput is improved because upload speeds are generally slower than download speeds.

In one implementation, different versions of the selected video clip are selected and downloaded according to the capabilities of the recipient client system. More particularly, the host-based video clips may be selected for downloading according to the capability of the client system on which they will be rendered. The capabilities of the recipient client system include the connection of the client system to the host system (e.g., broadband or narrowband) as well as the processor speed and memory size and type of the client system. Thus, a sender with a narrowband connection may conduct a video IM session with a recipient using a broadband connection, and both the sender and the recipient will be provided with an appropriate version of a selected video clip which is sent from the sender to the recipient or from the recipient to the sender. A user gets the best quality clip that the user's client system and network transport can support.

For example, two sets of video clips may be maintained, one for a broadband connected system and one for a narrowband connected system. The broadband version of the video clip may have a different identifier than the narrowband version of the video clip. In another example, only a broadband version is stored and a narrowband version of the video clip is derived from the broadband version of the clip. In other examples, other versions of the clips may be stored or derived to account for variables such as processor speed and memory of the client system.

The capabilities of the recipient client system may be determined, for example, by having the client system provide a report of the capabilities to the host system. The host system may store the capabilities of the recipient until an update is received. In another example, the recipient client system may store the capabilities locally at the recipient client system. In yet another example, the recipient client system may send the report of the capabilities to the sender client system.

The appropriate version of the selected video clip is determined based upon the capabilities of the recipient client system. The appropriate version may be determined by the host, by the recipient client system, or by the sender client system. For example, the determined capabilities of the recipient system may be used to select between a broadband version and a narrowband version of the selected video clip. As another example, the determined capabilities of the recipient system may be used to derive an appropriate version of the video clip from a stored version of the video clip.

In one implementation, a video clip is configured to expire upon the occurrence of a predetermined event, such as the passage of a predetermined length of time, the passage of a predetermined date, or a predetermined number of uses. If it is determined that the video clip has expired, access to the video clip will be disallowed.

In another implementation, a determination may be made as to whether the video clip has been banned, and access to the video clip will be disallowed if the video clip has been banned. For example, the video clip may be banned based on a report by a user, or based on a violation of a term of a service agreement.

In another implementation, a determination may be made as to whether the selected video clip is an official item, and the selected video clip is displayed if it is an official item.

As described above, one example of a video communications system is a video messenger system, such as is described in co-pending U.S. patent application Ser. No. 09/911,799, filed Jul. 25, 2001, which is incorporated herein by reference. Examples of a transport mechanism which may be used to support host-based video clips are described in co-pending U.S. patent application Ser. No. 10/305,015, filed Nov. 27, 2002; Ser. No. 10/334,027, filed Dec. 30, 2002; Ser. No. 10/334,128, filed Dec. 31, 2002; and Ser. No. 10/334,129, filed Dec. 31, 2002, each of which are incorporated herein by reference.

The described host-based video clip and transport mechanism is useful for applications of video communications, such as video messaging. Examples include personal video messaging sessions, video conferences/meetings, and distance learning applications. A similar mechanism may be useful in a system where a server attaches a clip based upon text or characters in a message before delivering the message to a recipient.

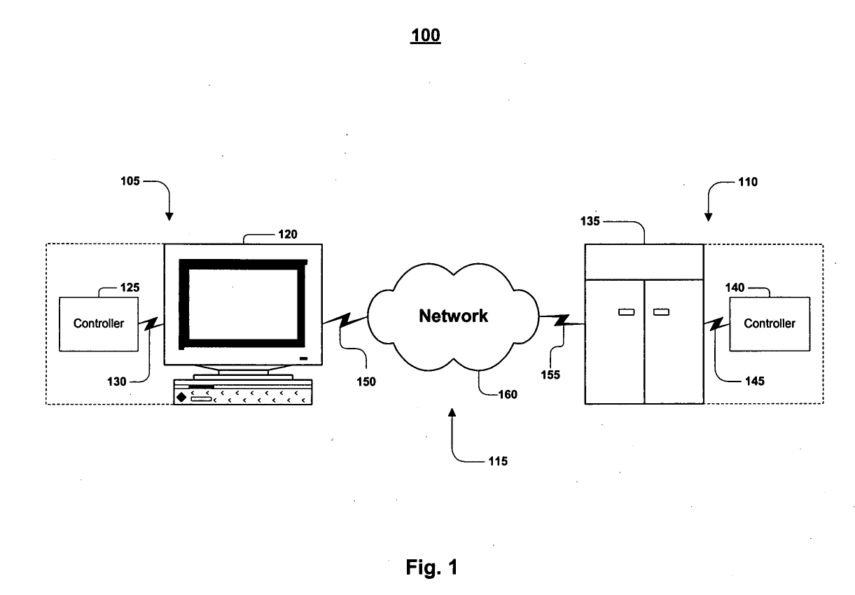

Referring to FIG. 1, a communications system 100 is capable of delivering and exchanging data between a sender system 105, such as an IM sender system, and a host system 110 through a communications link 115. The sender system 105 typically includes one or more client devices 120 and/or client controllers 125, and the host system 110 typically includes one or more host devices 135 and/or host controllers 140. For example, the sender system 105 or the host system 110 may include one or more general-purpose computers (e.g., personal computers), one or more special-purpose computers (e.g., devices specifically programmed to communicate with each other and/or the sender system 105 or the host system 110), or a combination of one or more general-purpose computers and one or more special-purpose computers. The sender system 105 and the host system 110 may be arranged to operate within or in concert with one or more other systems, such as, for example, one or more LANs (“Local Area Networks”) and/or one or more WANs (“Wide Area Networks”).

The client device 120 and the host device 135 are generally capable of executing instructions under the command of, respectively, a client controller 125 and a host controller 140. The client device 120 and the host device 135 are connected to, respectively, the client controller 125 and the host controller 140 by, respectively, wired or wireless data pathways 130 and 145, which are capable of delivering data.

The client device 120, the client controller 125, the host device 135, and the host controller 140 typically each include one or more hardware components and/or software components. An example of a client device. 120 or a host device 135 is a general-purpose computer (e.g., a personal computer) or software on such a computer capable of responding to and executing instructions in a defined manner. Other examples include a special-purpose computer, a workstation, a server, a device, a component, other physical or virtual equipment, or some combination of these capable of responding to and executing instructions. The client device 120 and the host device 135 may include devices that are capable of establishing peer-to-peer communications.

An example of client controller 125 or host controller 140 is a software application loaded on the client device 120 or the host device 135 for commanding and directing communications enabled by the client device 120 or the host device 135. Other examples include a program, a piece of code, an instruction, a device, a computer, a computer system, or a combination of these for independently or collectively instructing the client device 120 or the host device 135 to interact and operate as described. The client controller 125 and the host controller 140 may be embodied permanently or temporarily in any type of machine, component, physical or virtual equipment, storage medium, or propagated signal capable of providing instructions to the client device 120 and the host device 135.

The communications link 115 typically includes a delivery network 160 that provides direct or indirect communication between the sender system 105 and the host system 110, irrespective of physical separation. Examples of a delivery network 160 include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. The communications link 115 may include communication pathways 150 and 155 that enable communications through the one or more delivery networks 160 described above. Each of the communication pathways 150 and 155 may include, for example, a wired, wireless, cable or satellite communication pathway.

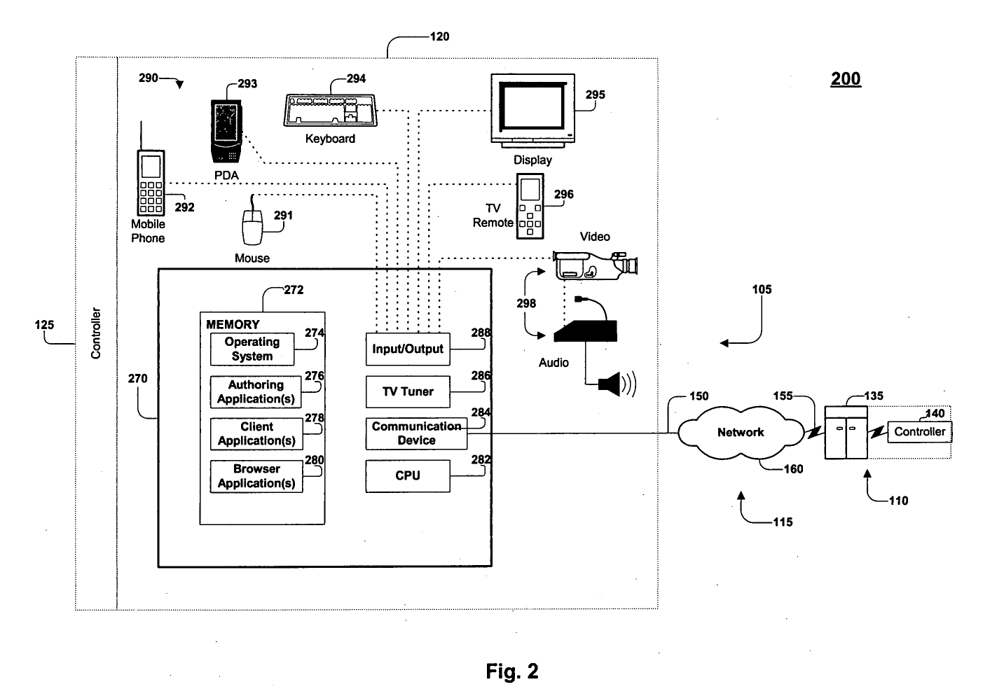

FIG. 2 illustrates a communications system 200 that includes a sender system 105 that communicates with a host system 110 through a communications link 115. The sender system 105 includes a client device 120 that typically includes a general-purpose computer 270 having an internal or external memory 272 for storing data and programs such as an operating system 274 (e.g., DOS, Windows™, Windows 95™, Windows 98™, Windows 2000™, Windows Me™, Windows XP™, Windows NT™, OS/2, or Linux) and one or more application programs. Examples of application programs include authoring applications 276 (e.g., word processing programs, database programs, spreadsheet programs, or graphics programs) capable of generating documents or other electronic content; client applications 278 (e.g., America Online (AOL) client, CompuServe client, AOL Instant Messenger (AIM) client, interactive television (ITV) client, Internet Service Provider (ISP) client, or instant messaging (IM) client) capable of communicating with other computer users, accessing various computer resources, and viewing, creating, or otherwise manipulating electronic content; and browser applications 280 (e.g., Netscape's Navigator or Microsoft's Internet Explorer) capable of rendering standard Internet content and other content formatted according to standard protocols such as the Hypertext Transfer Protocol (HTTP).

One or more of the application programs may be installed on the internal or external storage 272 of the general-purpose computer 270. Alternatively, in another implementation, the client controller 125 may access application programs externally stored in and/or performed by one or more device(s) external to the general-purpose computer 270.

The general-purpose computer 270 also includes a central processing unit (CPU) 282 for executing instructions in response to commands from the client controller 125, and a communication device 284 for sending and receiving data. One example of the communication device 284 is a modem. Other examples include a transceiver, a set-top box, a communication card, a satellite dish, an antenna, a network adapter, or some other mechanism capable of transmitting and receiving data over the communications link 115 through a wired or wireless data pathway 150. The general-purpose computer 270 optionally includes a television (“TV”) tuner 286 for receiving television programming in the form of broadcast, satellite, and/or cable TV signals. The TV tuner 286 permits the client device 120 to selectively and/or simultaneously display network content received by communications device 284 and TV programming content received by the TV tuner 286.

The general-purpose computer 270 may include an input/output interface 288 that enables wired or wireless connection to various peripheral devices 290. Examples of peripheral devices 290 include, but are not limited to, a mouse 291, a mobile phone 292, a personal digital assistant (PDA) 293, an MP3 player (not shown), a keyboard 294, a display monitor 295 with or without a touch screen input, a TV remote control 296 for receiving information from and rendering information to users, and an audiovisual input device 298.

Although FIG. 2 illustrates devices such as a mobile telephone 292, a PDA 293, and a TV remote control 296 as being peripheral with respect to the general-purpose computer 270, in another implementation, such devices may themselves include the functionality of the general-purpose computer 270 and operate as the client device 120. For example, the mobile phone 292 or the PDA 293 may include computing and networking capabilities and function as a client device 120 by accessing the delivery network 160 and communicating with the host system 110. Furthermore, the sender system 105 may include one, some or all of the components and devices described above.

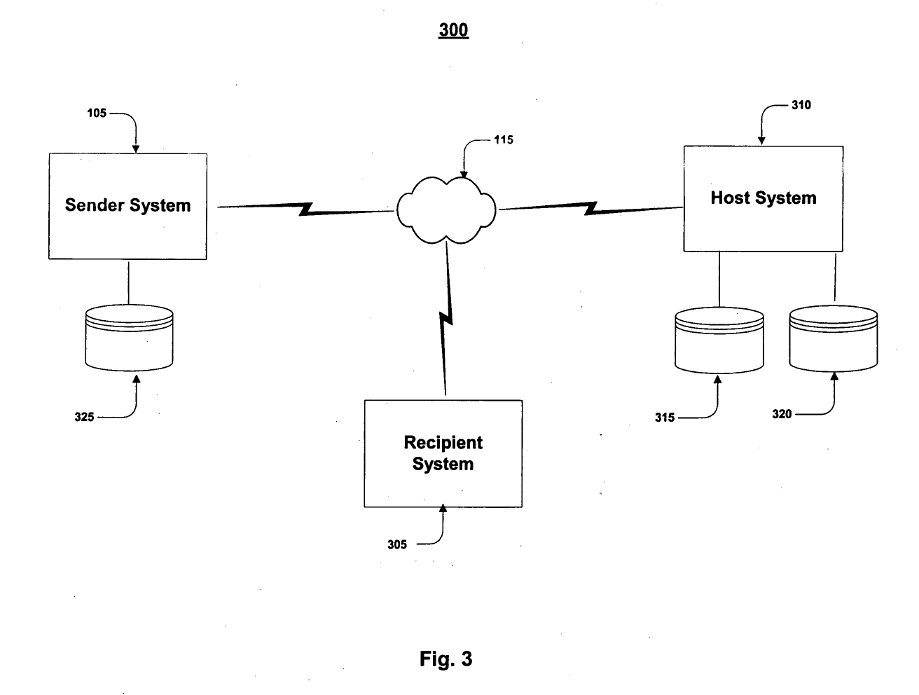

FIG. 3 illustrates a communications system 300 including a sender system 105 communicating with a recipient system 305, such as an IM recipient system, and a host system 310, such as an IM host system, through a communication link 115. Such a communications system may be used by users of IM service providers, such as, for example, AIM, ICQ, Yahoo Messenger, and Microsoft Messenger.

In one implementation, the host system 310 may have characteristics similar to those described above with respect to the host system 110, the recipient system 305 may have characteristics similar to those described above with respect to the sender system 105, and the sender system 105 and the recipient system 305 may include communication software to enable users of the client systems to access the host system 310.

The host system 310 may support IM services irrespective of a sender's network or Internet access. Thus, the host system 310 may allow users to send and receive IMs, regardless of whether they have access to any particular ISP. The host system 310 also may support associated services, such as administrative matters, advertising, directory services, chat, and interest groups related to the IM. The host system 310 has an architecture that enables the devices (e.g., servers) within the host system 310 to communicate with each other. To transfer data, the host system 310 employs one or more standard or proprietary IM protocols.

To access the host system 310 to begin an IM session in the implementation of FIG. 3, the sender system 105 establishes a connection to the host system 310. Once a connection to the host system 310 has been established, the sender system 105 may directly or indirectly transmit data to and access content from the host system 310. By accessing the host system, a sender can use the IM client application to view whether particular users are online, exchange IMs with particular recipients, participate in group chat rooms, trade files such as pictures, invitations or documents, find other recipients with similar interests, get customized information such as news and stock quotes, and search the Web. Recipient system 305 may be similarly manipulated to establish a contemporaneous connection with host system 310.

Once connectivity is established, a sender who is using sender system 105 may view whether a recipient using recipient system 305 is online, and typically may view whether the recipient is able to receive IMs. If the recipient is online, the sender may exchange IMs with the recipient.

Furthermore, the sender may view or perceive certain aspects of a personality selected by a potential recipient prior to engaging in communications with that potential recipient. For example, certain aspects of a recipient selected personality, such as a buddy icon or a miniature buddy icon chosen by the recipient, may be perceivable through the buddy list itself prior to engaging in communications. Other aspects of a selected personality chosen by a recipient may be made perceivable upon opening of a communication window by the sender for a particular recipient but prior to initiation of communications.

In one implementation, the IMs sent between sender system 105 and recipient system 305 are routed through host system 310. In another implementation, the IMs sent between sender system 105 and recipient system 305 are routed through a third party server (not shown), and, in some cases, are also routed through host system 310. In yet another implementation, the IMs are sent directly between sender system 105 and recipient system 305.

As shown in FIG. 3, the host system may include a data store 315 for one or more personalities for one or more instant messaging senders. The host system may also include a data store 320 for available attributes of personalities. The attributes may include easily selectable items made available to a user while building a personality and as such, are not intended to represent all possible options. The personalities also may be stored locally in a data store 325 at the sender system 105.

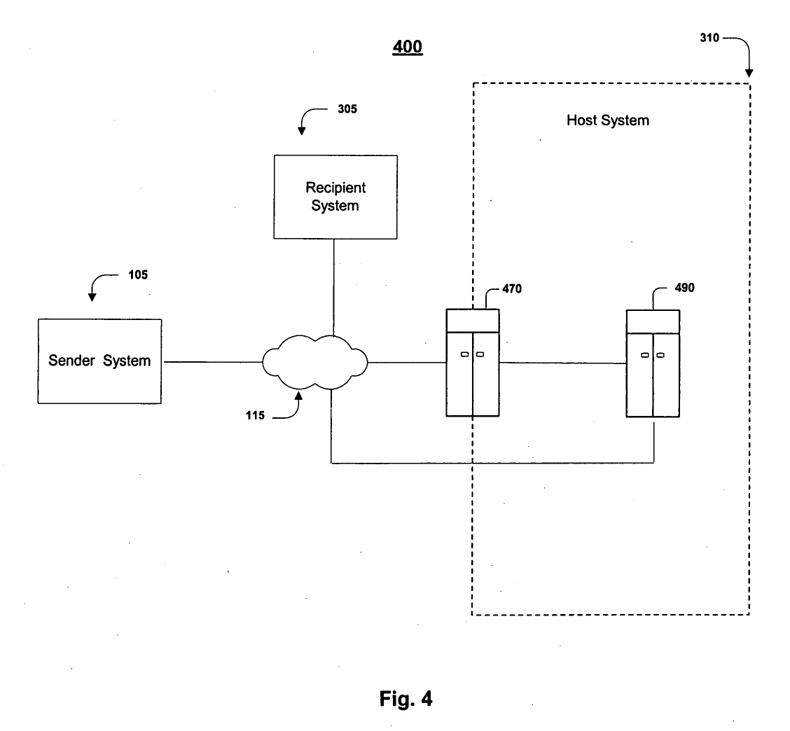

FIG. 4 illustrates a communications system 400 that includes a sender system 105 communicating with a recipient system 305 and a host system 310 through a communication link 115. System 400 illustrates a possible implementation of the communications system 300 of FIG. 3.

In system 400, the host system 310 includes a login server 470 for enabling access by senders and routing communications between the sender system 105 and other elements of the host system 310. The host system 310 also includes a server 490, such as an IM server. To enable access to and facilitate interactions with the host system 310, the sender system 105 and the recipient system 305 may include communication software, such as for example, an OSP client application and/or an IM client application.

As described with respect to FIG. 3, the host system 310 may support IM services irrespective of a sender's network or Internet access. Thus, the host system 310 may allow senders to send and receive IMs, regardless of whether they have access to any particular ISP. The host system 310 also may support associated services, such as administrative matters, advertising, directory services, chat, and interest groups related to the IM. The host system 310 has an architecture that enables the devices (e.g., servers) within the host system 310 to communicate with each other. To transfer data, the host system 310 employs one or more standard or exclusive IM protocols.

In one implementation, the sender system 105 establishes a connection to the login server 470 in order to access the host system 310 and begin an IM session. The login server 470 typically determines whether the particular sender is authorized to access the host system 310 by verifying the sender's identification and password. If the sender is authorized to access the host system 310, the login server 470 usually employs a hashing technique on the sender's screen name to identify a particular server 490 within the host system 310 for use during the sender's session. The login server 470 provides the sender (e.g., sender system 105) with the IP address of the server 490, gives the sender system 105 an encrypted key, and breaks the connection. The sender system 105 then uses the IP address to establish a connection to the particular server 490 through the communications link 115, and obtains access to the server 490 using the encrypted key. Typically, the sender system 105 will be able to establish an open TCP connection to the server 490. The recipient system 305 establishes a connection to the host system 210 in a similar manner.

In one implementation, the sender system 105 may directly or indirectly transmit data to and access content from the server 490 once a connection to the server 490 has been established. By accessing the server, a sender can leverage the IM client application to determine whether particular recipients (“buddies”) are online, exchange IMs with particular recipients, participate in group chat rooms, trade files such as pictures, invitations or documents, find other recipients with similar interests, get customized news and stock quotes, and search the Web. For example a sender who is using sender system 105 may view whether a buddy using recipient system 305 is online, and if so, may exchange IMs with that buddy. In one implementation, the IMs sent between sender system 105 and recipient system 305 are routed through host system 310. In another implementation, the IMs sent between sender system 105 and recipient system 305 are routed through a third party server (not shown) and, in some cases, are also routed through host system 310. In yet another implementation, the IMs are sent directly between sender system 105 and recipient system 305.

In one implementation, the host system 310 also includes a user profile server (not shown) connected to a database (not shown) for storing large amounts of user profile data. The user profile server may be used to enter, retrieve, edit, manipulate, or otherwise process user profile data. In one implementation, a sender's profile data includes, for example, the sender's screen name, buddy list, identified interests, and geographic location. The sender's profile data may also include self-expression items selected by the sender. The sender may enter, edit and/or delete profile data using an installed IM client application on the sender system 105 to interact with the user profile server.

Because the sender's data are stored in the host system 310, the sender does not have to reenter or update such information in the event that the sender accesses the host system 310 using a new or different sender system 105. Accordingly, when a sender accesses the host system 410, the server can instruct the user profile server to retrieve the sender's profile data from the database and to provide, for example, the sender's self-expression items and buddy list to the server. Alternatively, user profile data may be saved locally on the sender system 105.

Instant messaging programs typically allow senders to communicate in real-time with each other in a variety of ways. For example, many instant messaging programs allow senders to send text as an instant message, to transfer files, and to communicate by voice. Examples of IM communications exist over AIM (America Online Instant Messenger), AOL (America Online) Buddy List and Instant Messages, Yahoo Messenger, MSN Messenger, and ICQ, among others. Although discussed primarily with respect to IM applications, other implementations are contemplated for providing similar functionality in platforms and online applications such as chat, e-mail, and streaming media applications.

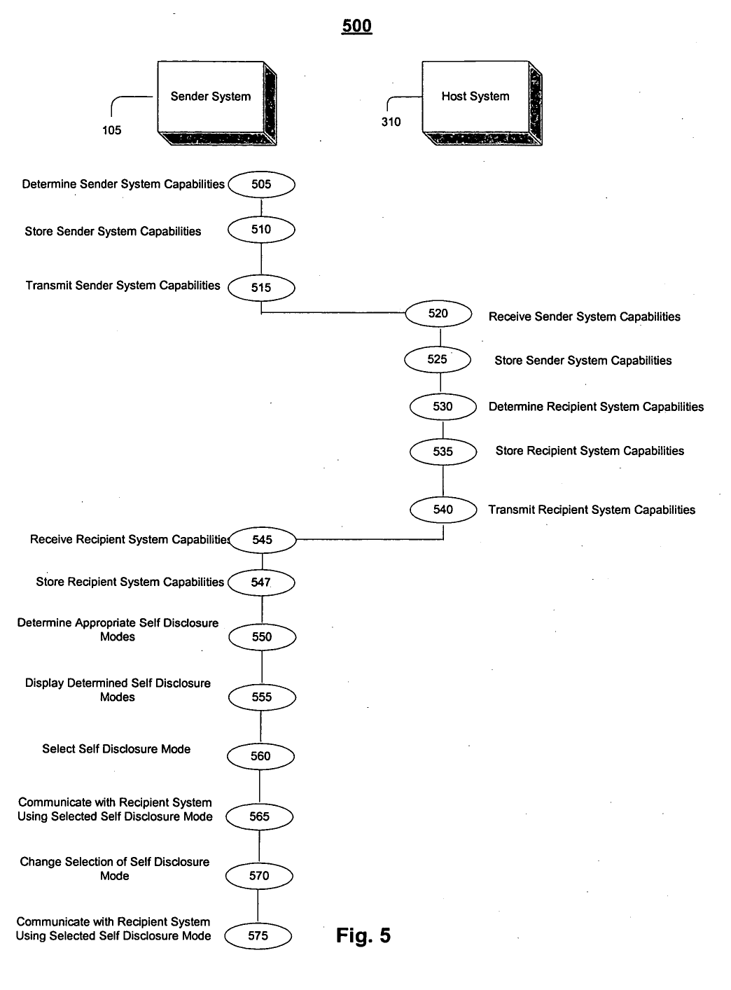

FIG. 5 shows an exemplary procedure 500 to enable a sender to regulate self-disclosure during a communications session with a recipient. The procedure 500 may be implemented in a client/host context, or a standalone or offline client context. For example, while some functions of procedure 500 may be performed entirely by the sender system 105, other functions may be performed by the host system 110, or the collective operation of the sender system 105 and the host system 110. In procedure 500, one or more modes of self-disclosure may be respectively selected and rendered by the standalone/offline device, and one or more modes of self-disclosure may be accessed or updated through a remote device in a non-client/host environment such as, for example, a LAN server serving an end user or a mainframe serving a terminal device. Thus, the procedure 500 described below may be implemented for an OSP, ISP, browser and/or other software program having a graphical user interface, such as programs for instant messaging, chat, electronic mail and stand-alone browsers. Moreover, procedure 500 may be implemented by hardware, software, devices, computers, computer systems, equipment, components, programs, applications, code, storage media, or propagated signals.

Procedure 500 generally involves controlling self-disclosure by selecting and projecting a self-disclosure mode. Self-disclosure modes for communications applications such as video messaging applications include modes that employ text only, a static picture with a sound file, a pre-recorded video clip such as a movie or cartoon clip, and a user-recorded video and audio clip.

The sender system 105 determines the capabilities of the sender system (step 505). For example, the sender system 105 may determine whether it is capable of recording video and/or audio clips, and whether it has a high speed or a low speed connection to the host system 310. The sender system 105 may determine its capabilities in several ways, such as through the running of a diagnostic program, solicitation of user input, receiving data from an outside source or retrieving data from a storage location. The determined sender system capabilities may be stored (step 510) in storage locations such as a data store located on the sender system 105 or the host system 310.

In one implementation, the sender system 105 may transmit its capabilities to the host system 310 (step 515). The host system receives the sender system capabilities (step 520) and stores the sender system capabilities (step 525) in a data store such as a data store located at the host system 310.

Next, the host system 310 determines the capabilities of the recipient system (step 530). For example, the host system 310 may determine whether the recipient system is capable of recording video and/or audio clips, and whether the recipient system has a high speed or a low speed connection to the host system 310. The host system 310 may determine the recipient system capabilities in several ways, such as soliciting input from the recipient system, receiving data from an outside source, retrieving data from a storage location, or by causing the running of a diagnostic program on the recipient system. The determined recipient system capabilities may be stored (step 535) in storage locations such as a data store located on the host system 310 or the recipient system. The host system 310 may transmit the recipient system capabilities to the sender system 105 (step 540).

The sender system 105 receives the recipient system capabilities (step 545) from the host system 310. In other implementations, the sender system 105 may receive the recipient system capabilities directly from the recipient system or from a different data source. The sender system 105 may store the recipient system capabilities (step 547) in a data store such as a data store located at the host system 310.

Next, the sender system 105 determines appropriate self-disclosure modes (step 550). In one implementation, the appropriate self-disclosure modes may be determined automatically by the sender system based upon the determined capabilities of the sender system 105 and/or the determined capabilities of the host. In other implementations, the appropriate self-disclosure modes may be a pre-determined set of modes, a set of modes determined based upon the identity of an intended recipient, such as the identity of a buddy on a buddy list, a set of modes determined through user input, or a set of modes chosen by the host system 310.

The determined set of self-disclosure modes may be displayed (step 555). For example, the set of self-disclosure modes may be displayed to the sender in a user interface (UI). All of the determined modes may be displayed, or a subset of modes may be displayed. For example, the set of modes displayed may be context sensitive based upon prior communications with the particular recipient. In another implementation, all possible modes may be displayed, or the determined modes may be displayed in a way that distinguishes the determined modes from modes which were not determined to be appropriate.

A self-disclosure mode is selected (step 560). The self-disclosure mode may be automatically selected for the sender based upon a default value. For example, the sender may choose to default to a conservative level of self disclosure such as text only or a static picture with a pre-recorded sound clip such as a movie or cartoon audio clip. The selection may be made in other ways. For example, the selection may be made based upon the identity or other characteristic of the recipient or based upon the last mode used in communications with the recipient. In another implementation, the selection may be made manually by the sender through, for example, manipulation of a UI. The sender then communicates with the recipient using the selected self-disclosure mode (step 565).

The self-disclosure mode may be changed to a different mode (step 570). For example, if the sender is comfortable in revealing more information about herself, she may switch from a more conservative self-disclosure mode to a self-disclosure mode that reveals more information. As an example, the sender may change from a text only mode to a mode having a static picture of the sender with the sender's recorded voice clips. The change may be made manually by the sender or may be made automatically based on criteria such as the passage of a pre-determined amount of time or a certain number of messages exchanged. The sender then communicates with the recipient using the newly selected self-disclosure mode (step 575).

Host-based video clips may be used as a component of a system that enables a sender to regulate self-disclosure, or for other purposes. FIG. 5 shows an exemplary procedure 500 that may be implemented by such a system.

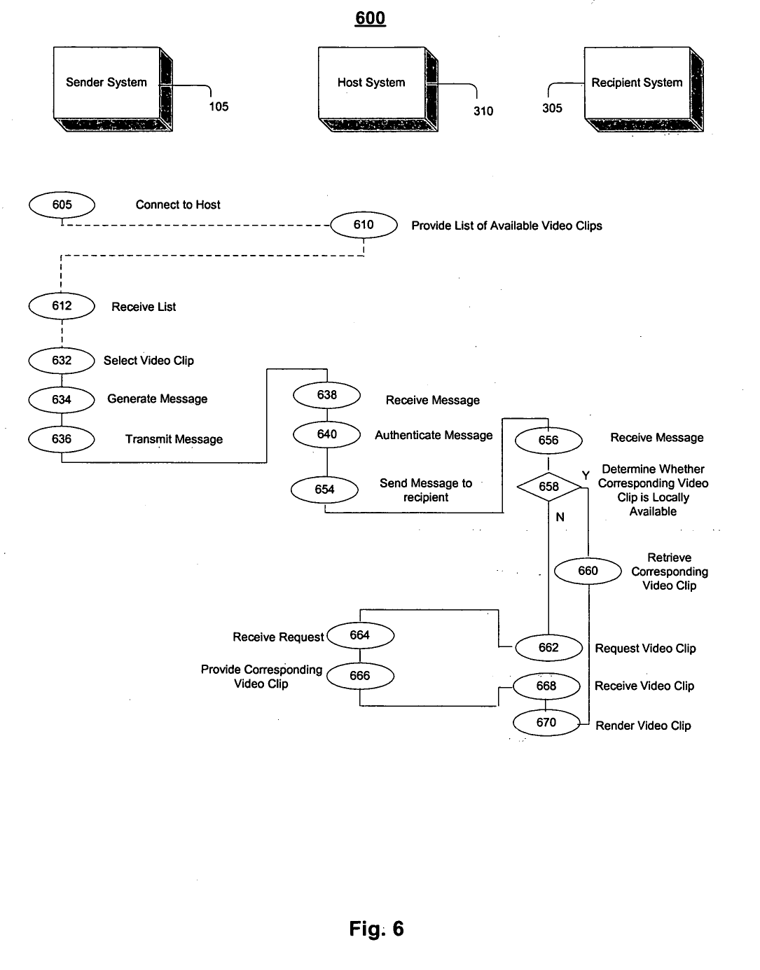

FIG. 6 shows an exemplary procedure 600 to enable a sender to send a host-based video clip to a recipient during a communications session with the recipient. The video clip may include media data of finite length, such as, for example, a finite length of audio-visual data, a finite length of audio data, or a finite length of visual data. The video clip may be a clip of a movie, a cartoon, or a television program, or may have other content such as user provided content.

The procedure 600 may be implemented in a client/host context, or a standalone or offline client context. For example, while some functions of procedure 600 may be performed entirely by the sender system 105, other functions may be performed by host system 310, or the collective operation of the sender system 105 and the host system 310. In procedure 600, one or more host-based video clips may be respectively selected and rendered by the standalone/offline device, and one or more modes of self-disclosure may be accessed or updated through a remote device in a non-client/host environment such as, for example, a LAN server serving an end user or a mainframe serving a terminal device. Thus, the procedure 600 described below may be implemented for an OSP, ISP, browser and/or other software program having a graphical user interface, such as programs for instant messaging, chat, electronic mail and stand-alone browsers. Moreover, procedure 600 may be implemented by hardware, software, devices, computers, computer systems, equipment, components, programs, applications, code, storage media, or propagated signals.

Procedure 600 generally involves selecting and transmitting host-based video clips. The sender system 105 is physically or logically connected to the host system 310 (step 605). For instance, sender system 105 may connect to the host system 310 across a network (e.g., network 160) by supplying a sender identification and password to a server (e.g., a login server) in order to obtain access to the host system 310.

The host system 310 optionally may provide the sender system 105 with a list of available video clips (step 610), which may include a list of video clip identifiers, such as file names or other identifiers of the video clips. In one implementation, the host system may provide updates to a previously provided list of video clips. For example, if certain video clips have been added, changed, deleted, banned or expired, data for these changes may be transmitted to the sender system 105. The update may be automatic or may be requested by the sender system 105.

The sender system 105 may receive the list of available video clips or updates to the list of available video clips when first accessing host system 310 (step 612), or at a later time, assuming that updates exist. The list of available video clips, or updates to the list received by sender system 105, may be stored locally at the sender system 105.

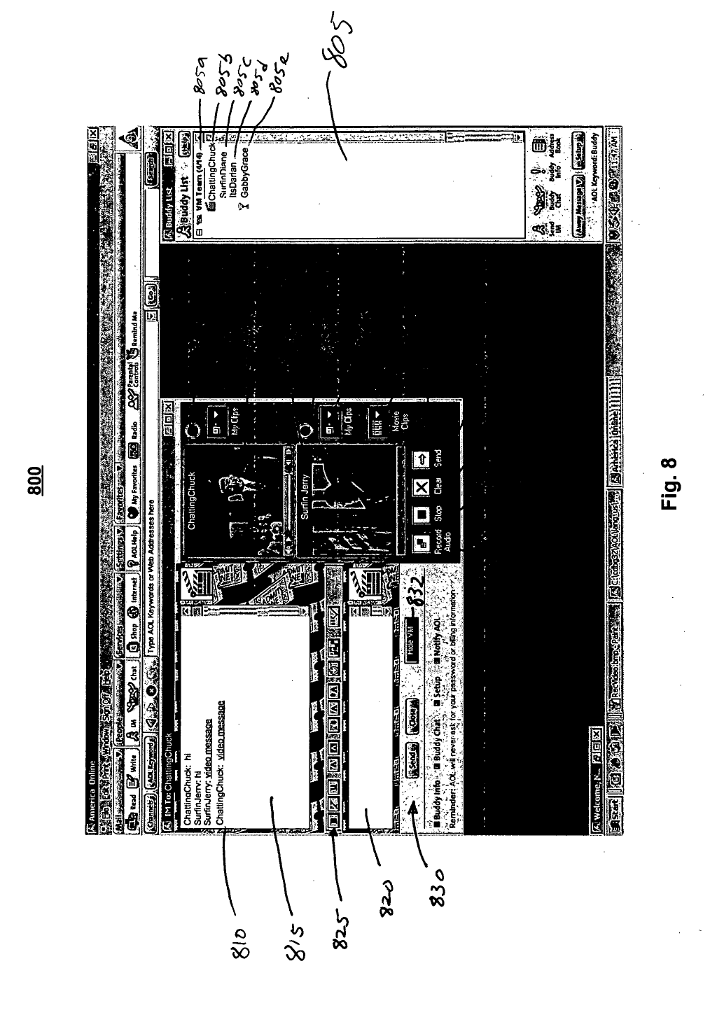

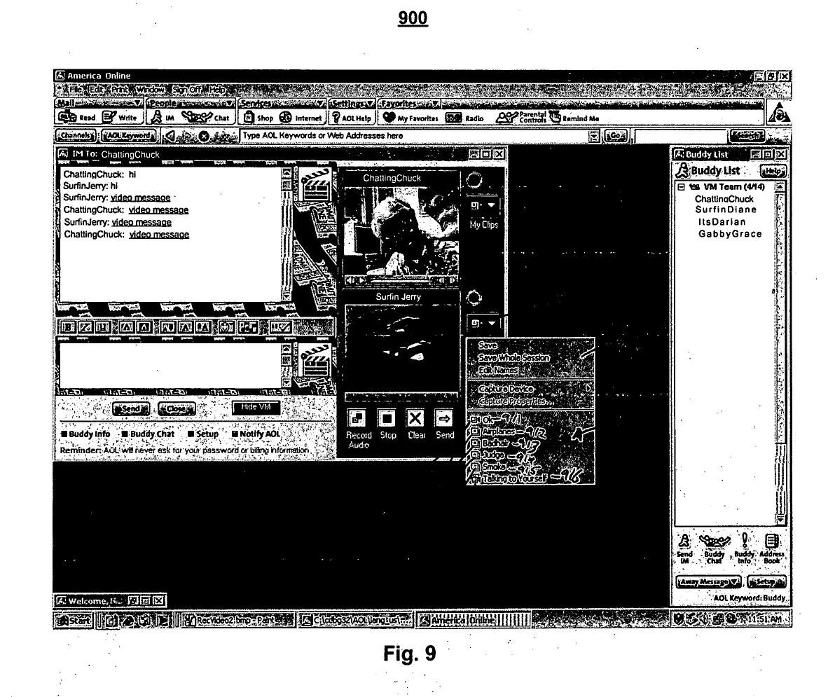

A video clip is selected at the sender system 105 (step 632). The video clip may be selected by the sender through manipulation of a UI. For example, the sender may select a video clip from a menu of available video clips using a mouse or other input device. Selecting the video clip may include selecting a clip identifier associated with the desired video clip. As discussed below with respect to FIGS. 8 and 9, the selection may be made with the assistance of user interfaces 800 and 900, and the sender may make the selection using a mouse or other input device. In another implementation, the video clip may be selected automatically for the sender. For example, the video clip may be selected based upon an identity or other characteristic of the recipient, or the video clip may be selected based upon the content of a message from the recipient. The video clip that is selected automatically may be sent automatically or may be presented to the sender for final approval before sending.

The available video clips may be made available to the sender system and rendered at the sender system for example, for the purpose of previewing the clips, by selecting the clip identifiers corresponding to the video clips. An identifier may be associated with a video clip or a specific version of the video clip (e.g., narrowband or broadband) and stored locally at the sender system, or the sender system may retrieve the identifier associated with the video clip from another location, such as the host system or another remotely-accessible data store.

If the sender desires to view a video clip, the sender system typically uses the clip identifier to determine if the corresponding video clip is available locally at the sender system, and, if so, the sender system retrieves the corresponding video clip for rendering to the sender. If the video clip is not available locally at the sender system, the sender system requests the video clip from another location such as the host system or another remotely-accessible data store. Once the sender system locates or receives the video clip, the sender system renders the video clip for perception by the sender.

Thereafter, a message such as an instant message is generated by the sender system 105 to be sent to the recipient system 305 (step 634). Typically, the selected video clip is the message. In some implementations, the video clip may be supplemented by, for example, an additional text message. In one implementation, the sender may generate the message by manipulating a UI, such as UIs 800 and 900 shown in FIGS. 8 and 9 and discussed below.

Next, the sender system 105 transmits the message to the host system 310 (step 636). The message may be the clip identifier, and may also have instructions or attributes that enable the recipient system to identify the message as a video clip for rendering to the recipient. The message may be transmitted, for example, by selecting a send control 874 in UI 800, as discussed below.

The host system 310 receives the message (step 638). The host system 310 then may authenticate the message for security purposes (step 640).

The host system 310 sends the message to the recipient system 305 (step 654). In one implementation, the host system 310 assigns an identifier to the video clip. In another implementation, the sender system assigns the identifier to the video clip.

The recipient system 305 receives the message from the host system 310 (step 656). Receiving the message may include receiving a clip identifier corresponding to the video clip selected by the sender system 105.

Next, the recipient system 305 determines whether the corresponding video clip is available locally (step 658). For example, the recipient system 305 may have stored the video clip in a local memory or another local storage location. The recipient system 305 uses the clip identifier to determine whether the corresponding video clip is available locally. For instance, the identifier may contain the location at which the corresponding video clip is stored.

If the corresponding video clip is available locally, the recipient system 305 retrieves the corresponding video clip (step 660) and render the video clip at the recipient system (step 670).

Otherwise, if the corresponding video clip is not available locally, the recipient system 305 requests the corresponding video clip from the host system 310 or a location otherwise specified by or inferred from the identifier, such as the sender system 105 or a remote, third party server (step 662). In one implementation, the video clip may be provided by a third party, and may be made available in consideration of a payment by the sender or the recipient. Requesting the corresponding video clip may include sending to the host system 310 the clip identifier associated with the video clip and also may include sending an explicit or implied request to download the video clip to the recipient system 305.

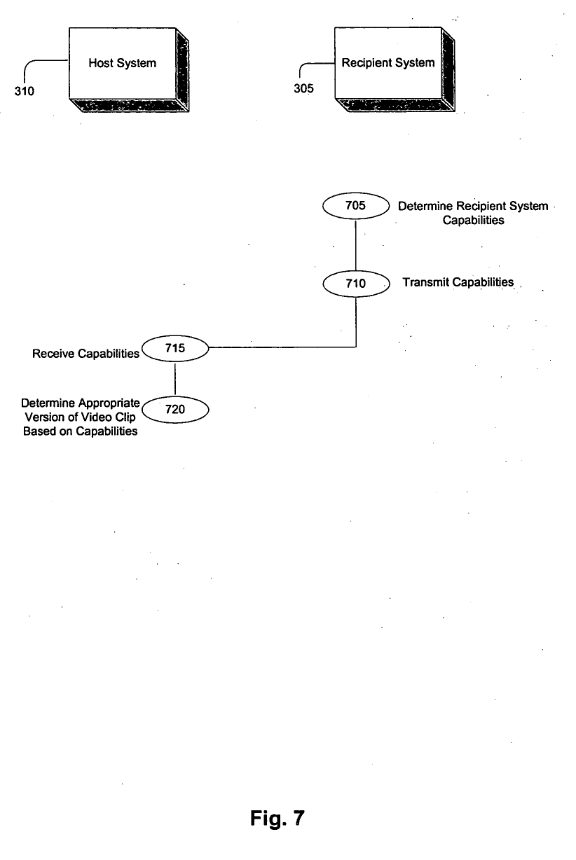

The host system 310 receives the request for the video clip from the recipient system 305 (step 664). Receiving the request may include receiving the clip identifier associated with the video clip and an explicit or implied request to download the video clip to the recipient system 305. The host system 310 provides the corresponding video clip to the recipient system 305 (step 666). As discussed below with respect to FIG. 7, providing the corresponding video clip to the recipient system may include providing an appropriate version of the video clip, such as a narrowband version or a broadband version.

If the video clip is not available at the host system 310, the host system may request the video clip from an appropriate source, such as sender system 105 or a remote, third party server or data store.

The corresponding video clip is received by the recipient system 305 (step 668). Receiving the corresponding video clip may include saving the video clip in a memory or other storage at the local recipient system 305.

Finally, the video clip is rendered (step 670) at the recipient system.

The relative order of steps 605-630 with respect to other steps in procedure 600 may vary. Also, certain steps may be omitted entirely, as appropriate. For example, step 640 may be eliminated such that, after receiving message from the sender system, the host next sends the message to the recipient system.

FIG. 7 shows an exemplary procedure 700 to enable a recipient system to view an appropriate version of a video clip transmitted by a sender during a communications session with the sender. The procedure 700 may be used in conjunction with procedure 600 discussed above.

The recipient system 305 determines the capabilities of the recipient system (step 705). For example, the recipient system 305 may determine whether the recipient system is capable of recording video and/or audio clips, and whether the recipient system has a high speed or a low speed connection to the host system 310. The recipient system 305 may determine the recipient system capabilities in several ways, such as retrieving data from a storage location, running a diagnostic program on the recipient system, or receiving data from an outside source.

In another implementation, the host system 310 may determine the capabilities of the recipient system 305, and may do so in several ways, such as soliciting input from the recipient system, receiving data from an outside source, retrieving data from a storage location, or by causing the running of a diagnostic program on the recipient system.

The recipient system 305 transmits the recipient system capabilities to the host system 310 (step 710). The host system 310 receives the recipient system capabilities from the recipient system 305 (step 715). In other implementations, the host system 310 may receive the recipient system capabilities directly from the recipient system or from a different data source. The host system 310 may store the recipient system capabilities in a data store such as a data store located at the host system 310.

Then, the host system 310 determines the appropriate version of the video clip to be provided to the recipient system 305, as described, for example, with respect to step 660 of procedure 600 (step 720). In one implementation, the appropriate version of the video clip may be determined automatically by the host system based upon the determined capabilities of the recipient system 305. For example, if the recipient system 305 is determined to have a narrowband connection, then the host system may determine that a narrowband version of the video clip is appropriate. In another implementation, the appropriate video clip may be determined based upon an identity or other characteristic of an intended recipient. In yet another implementation, the appropriate version of the video clip may be determined through user input.

FIG. 8 shows an exemplary user interface (UI) 800 that may be presented to a sender. The UI 800 includes a co-user list 805, also known as a “buddy list.” The co-user list 805 includes a user-defined list of groups 805a of other users 805b, 805c, 805d, and 805e, and shows the online presence status for these other users. A communications session with one or more of the other users 805b, 805c, 805d, and 805e may be initiated through manipulation of the co-user list 805.

The UI 800 also includes an instant messaging (IM) UI 810 for an instant messaging communications session with another user, such as one of the other users from the co-user list 805. As shown in IM UI 810, the sender “SurfinJerry” and recipient “Chatting Chuck” are engaged in a communications session.

The IM UI 810 includes a conversation window 815, where text from the communications session is displayed. The window 815 may also display hyperlinks to video and/or audio communications sent during the communications session. A text message compose area 820 is provided for the sender to enter text. The text may be modified using font and appearance controls 825. A message may be sent using transmission controls 830. A control 832 is provided to alternatively display and hide a video messaging UI 835.

Video messaging UI 835 is part of the IM UI 810, and includes a recipient video window 840 to display audio, video, photographs, or other images and/or sound sent to the sender by the recipient. An indicator 845 is provided and may change visual appearance to indicate that data from the recipient is being received or being played. The screen name of the recipient, in this case “ChattingChuck,” is displayed at the top of the window 840.

Video messaging UI 834 also includes a sender video window 850 to display audio, video, photographs, or other images and/or sound that potentially may be sent to the recipient by the sender. The sender may preview, add, edit, or delete content in the window 850, and may choose to send a message once the sender is satisfied with the message. An indicator 855 is provided and may change visual appearance to indicate that data is being sent to the recipient or being manipulated by the sender. The screen name of the sender, in this case “SurfinJerry,” is displayed at the top of the window 850. Drop down menus 860 and 865 are provided for the sender to select pre-recorded video and/or audio clips. As shown, drop down menu 860 contains a list of clips that were recorded or selected by the sender, and drop down menu 865 contains a list of clips provided by a third party such as an ISP. By manipulating the drop down menu controls 860 and 865, the sender may quickly and easily select pre-processed content to send to the recipient.

A set of recording/transmission controls 870 are provided to the sender in UI 835 to enable the sender to record audio and/or video clips to send to a recipient. As shown, the controls 870 include a control 871 to start recording an audio clip, a control 872 to stop recording an audio clip, a control 873 to clear a recorded audio clip, and a control 874 to send a recorded audio clip.

The IM UI 810, including video messaging UI 835, enables the sender to select among several modes of self-disclosure. In particular, the sender may select among a text only mode, a “picture plus sound” mode of a photograph and recorded audio clip, and a video clip mode. The text only mode is the most conservative mode and reveals the least personal information about the sender. The picture plus sound mode reveals a photograph chosen by the sender and an audio clip of the sender's voice (or another audio source chosen by the sender). The video clip mode may reveal a pre-recorded audio and/or video clip of the sender, or may reveal a pre-recorded audio and/or video clip from a movie or cartoon, among other sources. Thus, the sender is able to control the level of self-disclosure to the recipient by selection of an appropriate mode during the communications session. Also, the clip-based nature of the communications allows the sender to control when and if a message is sent to the recipient, and what form that message will take.

FIG. 9 shows an exemplary user interface (UI) 900 that may be presented to a sender. UI 900 is similar to UI 800. In UI 900, the sender has manipulated drop down menu 860 to activate menu 905. Menu 905 includes a list 910 of pre-recorded audio and/or visual clips available for the sender to select and transmit to the recipient. As shown, the list 910 includes clips 911-916. The clips have associated icons 911a-916a. An icon may indicate the source of the content, or the nature of the content of the associated clip. For example, an icon may indicate that the source of a clip was a recording by the user or a pre-recorded clip provided by a third party. An icon also may indicate, for example, that the clip is an audio clip, a video clip, or an audio-visual clip. The sender may select a clip to send to the recipient from the list 910 through manipulation of a user input device such as a mouse. The clips on the list 910 may be stored at the host system 310 and, once selected by the sender, provided to the recipient as described above with respect to FIG. 6.

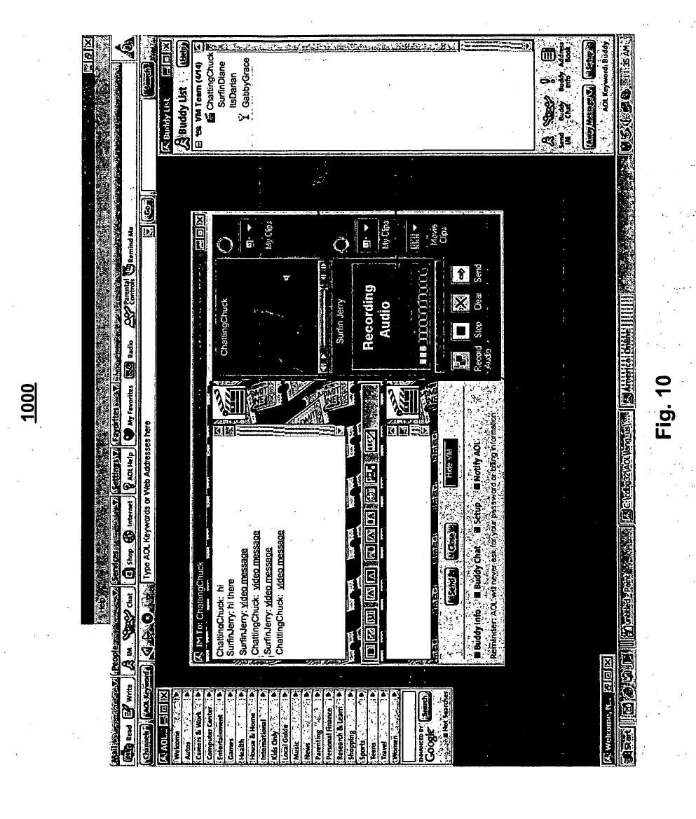

FIG. 10 shows an exemplary user interface (UI) 1000 that may be presented to a sender. UI 1000 is similar to UI 800. In UI 1000, the sender has manipulated a user input device to activate control 871. The sender video window 850 shows an indication 1005 that the sender is recording an audio clip. Typically, the audio clip is recorded using a microphone or sound recording device connected to the sender system 105. Once recorded, the sender may send the audio clip to the recipient by itself or with a visual image selected by the sender. The audio clip may be stored at the host system 310 and provided to the recipient as described above with respect to FIG. 6.

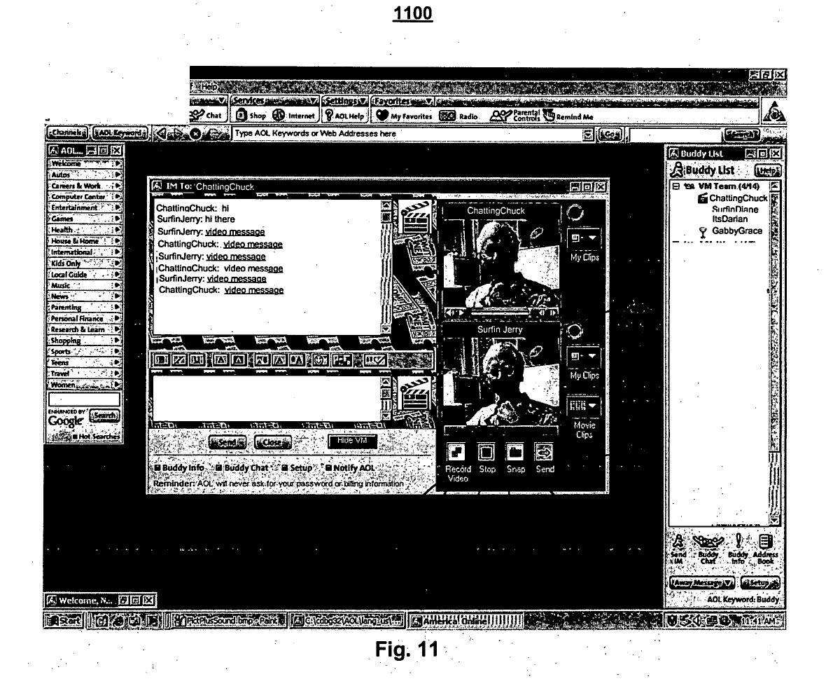

FIG. 11 shows an exemplary user interface (UI) 1100 that may be presented to a sender. UI 1100 is similar to UI 800. In UI 1100, the sender is presented with a slightly different set of controls 870 in the video messenger UI 835. In particular, controls are presented to record a video clip 1105, stop recording the video clip 1115, snap a still photograph 1120, and send the recorded video or still photograph 1125. The video clip typically is recorded using a video camera, such as a web cam, or other recording device connected to the sender system 105. The still photograph also may be snapped by a camera, such as a web cam, connected to the sender system 105.

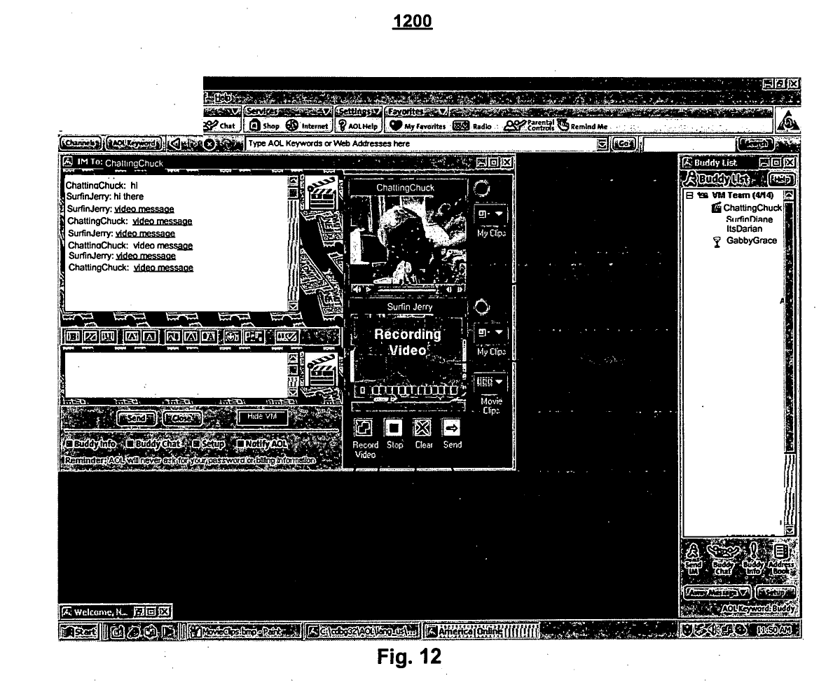

FIG. 12 shows an exemplary user interface (UI) 1200 that may be presented to a sender. UI 1200 is similar to UI 1100. In UI 1200, the sender has manipulated a user input device to activate the record video control 1110. The sender video window 850 shows an indication 1205 that the sender is recording a video clip. Optionally, the control to snap a still photograph 1120 may be removed from or hidden in the UI 835 once the record video control 1110 is activated. Once recorded, the sender may send the video clip to the recipient. The video clip may be stored at the host system 310 and provided to the recipient as described above with respect to FIG. 6.

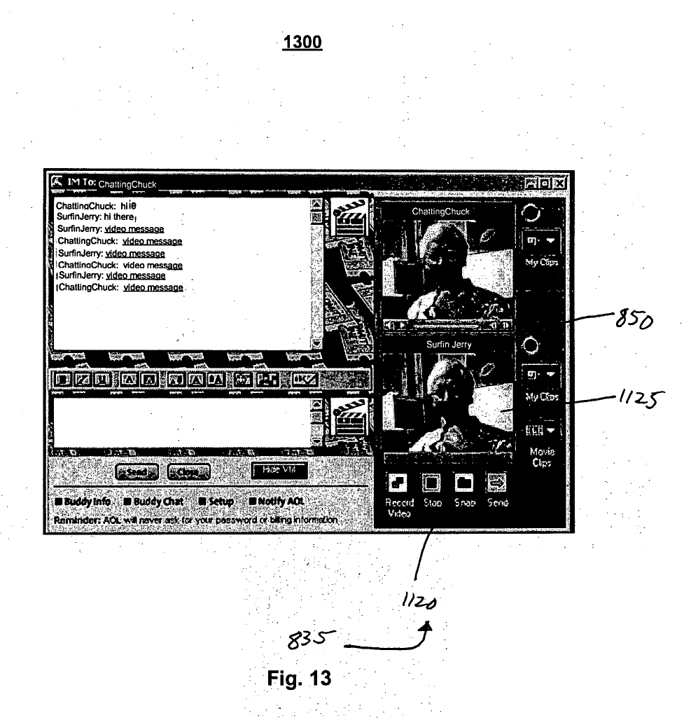

FIG. 13 shows an exemplary user interface (UI) 1300 that may be presented to a sender. UI 1300 is similar to UI 1100. In UI 1300, the sender has manipulated a user input device to activate the snap a photograph control 1120. The sender video window 850 shows the recorded still photograph. Optionally, the control to record a video segment 1105 may be removed from or hidden in the UI 835 once the record video control 1110 is activated. Once recorded, the sender may send the photograph to the recipient. The photograph may be stored at the host system 310 and provided to the recipient as described above with respect to FIG. 6.

Other implementations are within the scope of the following claims.

1. A computer implemented method for regulating a level of self-disclosure in an instant messaging communications session, the method comprising:
enabling user selection on a first instant messaging participant system of an instant messaging communications mode from among at least a first available mode and a second available mode, the first available mode disclosing a different amount of information about a first instant messaging participant than the second available mode;
enabling creation of a message clip on the first instant messaging participant system according to the selected communications mode; and
enabling delivery of the message clip from the first instant messaging participant system to a second instant messaging participant system.

2. The method of claim 1 further comprising storing the message clip on a host system.

3. The method of claim 2 wherein enabling delivery comprises enabling delivery of the message clip from the host system to the second instant messaging participant system.

4. The method of claim 1 further comprising:
selecting the first available mode;
creating a first message clip on the first instant messaging participant system according to the first available mode; and
delivering the first message clip from the first instant messaging participant system to the second instant messaging participant system.

5. The method of claim 4 further comprising:
selecting the second available mode;
creating a second message clip on the first instant messaging participant system according to the second available mode; and
delivering the second message clip from the first instant messaging participant system to the second instant messaging participant system.

6. A computer implemented method for regulating a level of self-disclosure in an instant messaging communications session, the method comprising:
rendering, on a first instant messaging participant system, an instant messaging application user interface for an instant messaging communications session involving at least a first instant messaging participant and a second instant messaging participant;
enabling user selection on the first instant messaging participant system of an instant messaging communications mode from among at least a first available mode and a second available mode, the first available mode disclosing a different amount of information about the first instant messaging participant than the second available mode, the user selection being enabled at least in part through display of the available modes at the instant messaging application user interface;
enabling creation of a message clip on the first instant messaging participant system according to the selected communications mode, the message clip being created at least in part through user interaction with the instant messaging application user interface; and
enabling delivery of the message clip from the first instant messaging participant system to a second instant messaging participant system in response to a user interaction with the instant messaging application user interface.

7. The method of claim 6 in which enabling user selection comprises enabling user selection of at least one of a text communications mode, an audio communications mode, a still photograph communications mode and a video communications mode.

8. The method of claim 6 in which enabling creation of a message clip comprises enabling selection of a pre-stored message clip.

9. The method of claim 8 wherein the pre-stored message clip is stored on a host system.

10. The method of claim 6 further comprising:
selecting the first available mode;
creating a first message clip on the first instant messaging participant system according to the first available mode; and
delivering the first message clip from the first instant messaging participant system to the second instant messaging participant system.

11. The method of claim 10 further comprising:
selecting the second available mode;
creating a second message clip on the first instant messaging participant system according to the second available mode; and
delivering the second message clip from the first instant messaging participant system to the second instant messaging participant system.

12. A computer program, stored on a computer readable medium, the computer program comprising instructions for:
enabling user selection on a first instant messaging participant system of an instant messaging communications mode from among at least a first available mode and a second available mode, the first available mode disclosing a different amount of information about a first instant messaging participant than the second available mode;
enabling creation of a message clip on the first instant messaging participant system according to the selected communications mode; and
enabling delivery of the message clip from the first instant messaging participant system to a second instant messaging participant system.

13. The computer program of claim 12 further comprising instructions for storing the message clip on a host system.

14. The computer program of claim 13 wherein instructions for enabling delivery comprises instructions for enabling delivery of the message clip from the host system to the second instant messaging participant system.

15. The computer program of claim 12 further comprising instructions for:
selecting the first available mode;
creating a first message clip on the first instant messaging participant system according to the first available mode; and
delivering the first message clip from the first instant messaging participant system to the second instant messaging participant system.

16. The computer program of claim 15 further comprising instructions for:
selecting the second available mode;
creating a second message clip on the first instant messaging participant system according to the second available mode; and
delivering the second message clip from the first instant messaging participant system to the second instant messaging participant system.

17. A computer program, stored on a computer readable medium, the computer program comprising instructions for:
rendering, on a first instant messaging participant system, an instant messaging application user interface for an instant messaging communications session involving at least a first instant messaging participant and a second instant messaging participant;
enabling user selection on the first instant messaging participant system of an instant messaging communications mode from among at least a first available mode and a second available mode, the first available mode disclosing a different amount of information about the first instant messaging participant than the second available mode, the user selection being enabled at least in part through display of the available modes at the instant messaging application user interface;
enabling creation of a message clip on the first instant messaging participant system according to the selected communications mode, the message clip being created at least in part through user interaction with the instant messaging application user interface; and
enabling delivery of the message clip from the first instant messaging participant system to a second instant messaging participant system in response to a user interaction with the instant messaging application user interface.

18. The computer program of claim 17 in which instructions for enabling user selection comprises instructions for enabling user selection of at least one of a text communications mode, an audio communications mode, a still photograph communications mode and a video communications mode.

19. The computer program of claim 17 in which instructions for enabling creation of a message clip comprises instructions for enabling selection of a pre-stored message clip.

20. The computer program of claim 19 wherein the message clip is stored on a host system.

21. The computer program of claim 17 further comprising instructions for:
selecting the first available mode;
creating a first message clip on the first instant messaging participant system according to the first available mode; and
delivering the first message clip from the first instant messaging participant system to the second instant messaging participant system.

22. The computer program of claim 21 further comprising instructions for:
selecting the second available mode;
creating a second message clip on the first instant messaging participant system according to the second available mode; and
delivering the second message clip from the first instant messaging participant system to the second instant messaging participant system.
